(19) United States
(12) Patent Application Publication
(10) Pub. No.: US 2025/0311724 A1
(43) Pub. Date: Oct. 9, 2025

(54) FORMULATION COMPRISING FLUDIOXONIL

(71) Applicant: SYNGENTA CROP PROTECTION AG, Basel (CH)

(72) Inventors: Raphael KLEBER, Münchwilen (CH); Philip LAMERS, Münchwilen (CH); Aikaterini TSOUTSOURA, Basel (CH)

(73) Assignee: SYNGENTA CROP PROTECTION AG, Basel (CH)

(21) Appl. No.: 18/865,582

(22) PCT Filed: May 13, 2022
(86) PCT No.: PCT/EP2022/063092

§ 371 Date: Nov. 13, 2024

(51) Int. Cl. A01N 43/36; A01N 25/04; A01N 25/30; A01P 3/00

(52) U.S. Cl. CPC A01N 43/36; A01N 25/04; A01N 25/30; A01P 3/00

(57) ABSTRACT

This invention relates to an aqueous composition comprising: (a) at least 10% by weight of fludioxonil over the total weight of the composition, (b) at least one polyoxyalkylene copolymer having an average molecular weight up to 4000 g/mol, (c) at least one dispersing agent, and (d) water.

This invention relates to a composition comprising fludioxonil. More particularly, this invention relates to formulations such as suspension concentrates (SC) or suspoemulsions (SE); to dilutions or dispersions of such formulations more particularly in a farmer's spray-tank; and to use of such a composition in agriculture or horticulture for controlling or preventing infestation of plants by phytopathogenic microorganisms, preferably fungi.

Fludioxonil is a fungicidal agrochemical commercially available under different types of formulation. When a high loading of fludioxonil is needed, there is not a lot of solution on the market. Water dispersible granules exist but this solid-state formulation encounters dust issue and require careful handling. Furthermore, such solid-state formulation does not present satisfying retention properties.

The aim of the present invention is to overcome the problems of the prior art techniques by proposing a composition comprising a high loading of fludioxonil which improves retention property while guaranteeing satisfying sprayable conditions.

To this end, an object of the present invention is to provide an aqueous composition comprising:
(a) at least 10% by weight of fludioxonil over the total weight of the composition,
(b) at least one polyoxyalkylene copolymer having an average molecular weight up to 4000 g/mol,
(c) at least one dispersing agent, and
(d) water.

Thanks to the aqueous composition of the present invention, all the above problems have been overcome. More particularly, the present invention provides an aqueous composition with improved retention properties, while guaranteeing a low viscosity to ensure good handling and satisfying sprayable conditions. Furthermore, thanks to a high loading of fludioxonil, a lower amount of composition is needed per Hectare. Another remarkable advantage of the present invention is that the composition also presents a good chemical and physical stability over time, especially when storing.

The composition of the present invention comprises at least one active ingredient which is fludioxonil. Fludioxonil is a fungicide with the following CAS number: 131341-86-1, and has the following chemical formula:

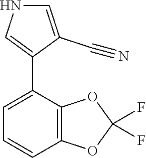 [SMILES: N#Cc1c[nH]cc1-c1cccc2c1OC(F)(F)O2]

Hence, the aqueous composition of the present invention is more particularly a fungicidal composition.

The present invention can have a high amount of active ingredient, especially a high amount of fludioxonil such as at least 10% by weight over the total weight of the composition. More particularly, the composition can comprise from 20 to 60% by weight of fludioxonil, preferably from 30 to 50% by weight of fludioxonil, and more preferably from 35 to 45% by weight of fludioxonil, over the total weight of the composition,

The composition can comprise one or several polyoxyalkylene copolymers (b) having an average molecular weight up to 4000, preferably up to 3000, preferably from 2000 to 3000 g/mol, preferably from 2100 to 3000 g/mol, and more preferably from 2200 to 2700 g/mol.

In the present invention, the expression “an average molecular weight of” means “a molecular weight which is approximately of”. Molecular weight of a polymer, or in other words the molar mass, can be easily determined by method well-known in the art, such as gel permeation chromatography (GPC).

The composition of the present invention can comprise from 1 to 30% by weight of polyoxyalkylene copolymer (b), preferably from 1 to 20% by weight of polyoxyalkylene copolymer (b), and more preferably from 5 to 10% by weight of polyoxyalkylene copolymer (b), over the total weight of the composition.

In the present invention, a polyoxyalkylene copolymer can be obtained from at least two different alkylene oxides, such as from ethylene oxide and propylene oxide monomers. The common name of such polyoxyalkylene copolymer is propylene oxide and ethylene oxide copolymer.

The polyoxyalkylene copolymer can be more preferably a polyoxyalkylene block copolymer of the AB, ABA, BAB, or ABABA type.

More particularly, the polyoxyalkylene copolymer can be prepared by ring-opening polymerization of the corresponding cyclic ethylene oxide and propylene oxide monomers.

Typically, the ring-opening polymerization is initiated by addition of water and alkali hydroxides, such as sodium hydroxide and potassium hydroxide. The block structure of the copolymer is formed by first polymerizing a polymer block using one monomer, before adding a second monomer to form further polymer blocks.

In a preferred embodiment, the polyoxyalkylene copolymer can be an ethylene oxide-propylene oxide-ethylene oxide block copolymer (EO-PO-EO block copolymer), or in other words a poly(ethylene oxide)-poly(propylene oxide)-poly(ethylene oxide) block copolymer or a poly(ethylene glycol)-poly(propylene glycol)-poly(ethylene glycol) block copolymer.

Examples include the GENAPOL® PF series (CLARIANT), the PLURONIC® series (BASF), the SYNPERONIC® PE series (CRODA), or the TOXIMUL® series (STEPAN).

When the polyoxyalkylene copolymer (b) is a EO-PO-EO block copolymer, the polyoxyalkylene copolymer (b) can comprise up to 50% by weight of the poly(ethylene oxide) block, preferably up to 40% by weight of the poly(ethylene oxide) block, and more preferably up to 30% by weight of the poly(ethylene oxide) block, over the total weight of the polyoxyalkylene copolymer (b). In this case, the polyoxyalkylene copolymer (b) can preferably comprise more than 10% by weight of the poly(ethylene oxide) block over the total weight of the polyoxyalkylene copolymer (b). In the present invention, the poly(ethylene oxide) block is also well known as polyethylene glycol block.

The composition of the present invention can comprise one or several dispersing agents (c), said dispersing agent(s) being more particularly different from the polyoxyalkylene copolymer (b).

The composition according to the invention can comprise from 0.1 to 20% by weight of dispersing agent, and preferably from 1 to 10% by weight of dispersing agent, over the total weight of the composition.

In a particular embodiment, the dispersing agent can be a polyoxyalkylene copolymer as previously defined, having an average molecular weight superior to 4000 g/mol, preferably from 5000 g/mol, and more preferably from 5600 to 6600 g/mol.

The polyoxyalkylene copolymer used as dispersing agent can be more preferably an ethylene oxide-propylene oxide-ethylene oxide block copolymer (EO-PO-EO block copolymer), or in other words a poly(ethylene oxide)-poly(propylene oxide)-poly(ethylene oxide) block copolymer or a poly(ethylene glycol)-poly(propylene glycol)-poly(ethylene glycol) block copolymer.

When the dispersing agent is an EO-PO-EO block copolymer, the dispersing agent can comprise at least 30% by weight of the poly(ethylene oxide) block, and preferably at least 40% by weight of the poly(ethylene oxide) block, over the total weight of the block copolymer.

In the present invention, the aqueous composition can comprise at least 10% by weight of water, preferably at least 20% by weight of water, preferably at least 30% by weight of water, and more preferably at least 40% by weight of water, over the total weight of the composition.

The composition of the invention can further comprise one or more formulation additives well-known in the art. In particular, the formulation additives can be selected among an anti-foam agent, a wetting agent, an anti-freeze agent, an anti-bacterial agent (or biocide), a viscosity modifier, and any mixture thereof.

Each of the above-cited formulation additives can be added into the composition to obtain the desired property. For example, each of the formulation additives can be added into the composition in an amount from 0.0001% to 10% by weight, and preferably from 0.001% to 5% by weight, over the total weight of the composition.

Other suitable formulation additives include amongst others known to the person skilled in the art, antioxidant, colourant, perfume, adjuvant, attractant, binder, buffer, solid support (carrier), coating agent, deodorant, emetic agent, inorganic filler, safener, pH modifier, and any mixture thereof.

The composition of the present invention may further comprise an additional agrochemical. The additional agrochemical can be an insecticide, another fungicide, an herbicide, a synergist, a plant growth regulator, a nematicide, a plant nutrient, a plant fertilizer, and any mixture thereof.

The composition of the present invention may comprise a suitable amount of one or several of the above-mentioned ingredient(s) to obtain the respective properties, when appropriate.

According to the present invention, the composition can be advantageously used as a suspension concentrate (SC) or a suspoemulsion (SE).

In a particular embodiment, the composition of the present invention may relate to:
a concentrate designed to be added to a farmer's spray tank of water, or
a suspension produced in a farmer's spray tank of water when a concentrate is mixed with water in the spray tank.

Another object of the present invention relates to a method of controlling or preventing an infestation of plants by fungal organisms, which comprises the foliar application of the composition according to the present invention.

In this foliar method, the composition of the present invention can be generally applied in spraying the composition, for example dispensed from a spray container.

Said foliar method can involve an effective amount of the composition applied at a rate of from 0.01 to 5 Litre per Hectare (L/ha), preferably from 0.02 to 3.0 L/ha, and more preferably from 0.1 to 2.0 L/ha.

Another object of the present invention relates to a use of the composition to control or prevent an infestation of plants by fungal organisms.

In the present invention, the composition can be used to treat oilseed rape, especially against Sclerotinia, Alternaria and/or Botrytis.

The following non-limiting examples demonstrate the improved behaviour associated with a composition according to the present invention.

The components used in the following examples are detailed as follows:
Fludioxonil is a fungicide (CAS number: 131341-86-1);
Pluronic™ PE 6200 is a polyoxyalkylene copolymer (b) having an average molecular weight of 2450 g/mol (CAS Number: 9003-11-6), supplied by BASF; and
Pluronic™ PE 6400 is a polyoxyalkylene copolymer (b) having an average molecular weight of 2900 g/mol (CAS Number: 9003-11-6), supplied by BASF;
Polyox WSR N10 is a poly(ethyleneoxide) (homopolymer) having an average molecular weight of 100.000 g/mol (CAS Number: 25322-68-3), supplied by DuPont
Geropon DOS PG is a sodium dioctyl sulfosuccinate (CAS Number: 577-11-7), supplied by Solvay;
Pluronic™ PE 10400 is a dispersing agent (c) which is a polyoxyalkylene copolymer having an average molecular weight of 5900 g/mol (CAS Number: 9003-11-6), supplied by BASF; and
Morwet D-425 is a dispersing agent which is a naphtalene sulfonic acid sodium salt (CAS Number: 68425-94-5), supplied by Nouryon.

The anti-freeze agent, the viscosity modifier, the biocide, the anti-foam agent and the wetting agent used in examples 1 to 6 are components well-known in the art to prepare suspension concentrate.

### EXAMPLES 1 AND 2

Examples 1 and 2 provide compositions according to the present invention, which are suspension concentrates (SC).

Under stirring the biocides and the wetting agent are added to 70% by weight of water. Pluronic™ PE 10400 (preheated to 50° C. for easier handling) was added to the mixture. After 10 min of stirring, the anti-foam agent and the anti-freeze agent were added. While stirring was continued Pluronic™ PE 6200 or Pluronic™ PE 6400 (preheated to 50° C. for easier handling) was added to the mixture. Fludioxonil was added to the mixture and it was stirred for 20 min. The resulting mixture was milled, using a Dyno mill KDL-special with 1 mm glass beads until a d₅₀<2.0 μm and a d₉₀<8.0 μm could be reached. The particle size distribution was measured, using a Malvern Mastersizer 3000. After reaching the particle size distribution, a previously prepared 2% mixture of a viscosity modifier in water and the rest of the water was added under stirring.

The concentrations of the components added to form the composition of Examples 1 and 2 are listed in the below Table 1, and are expressed in percentage by weight over the total weight of the composition (% w/w).

TABLE 1

| | Ex. 1 | Ex. 2 |
|---|---|---|
| Component | (% w/w) | (% w/w) |
| Fludioxonil | 41.5 | 41.5 |
| Pluronic ™ PE 6200 | 8.3 | 0 |
| Pluronic ™ PE 6400 | 0 | 8.3 |
| Pluronic ™ PE 10400 | 4.1 | 4.1 |
| Anti-freeze agent | 4.9 | 4.9 |
| Viscosity modifier | 0.12 | 0.12 |
| Biocides | 0.26 | 0.26 |
| Anti-foam agent | 0.41 | 0.41 |
| Wetting agent | 0.16 | 0.16 |
| Water | ad 100 (rest) | ad 100 (rest) |

### EXAMPLES 3-6

In Table 2 are gathered examples 1 and 2 as well as comparative examples 3-6. Comparative examples 3-6 are also suspension concentrate (SC) and were prepared identically as examples 1 and 2, except that the polyoxyalkylene copolymer (b) of the invention being replaced by Polyox WSR N10 (without preheating) or Geropon DOS PG (with preheating at 50° C. for easier handling), and the dispersing agent (c) of the invention being replaced by Morwet D-425 (without preheating).

The anti-freeze agent, the viscosity modifier, the biocide, the anti-foam agent and the wetting agent used in Table 2 are respectively identical between all the examples 1 to 6.

TABLE 2

| | Ex. 1 | Ex. 2 | Ex. 3 | Ex. 4 | Ex. 5 | Ex.6 |
|---|---|---|---|---|---|---|
| Component | (% w/w) | (% w/w) | (% w/w) | (% w/w) | (% w/w) | (% w/w) |
| Fludioxonil | 41.5 | 41.5 | 41.5 | 41.5 | 41.5 | 41.5 |
| Pluronic ™ | 8.3 | 0 | 0 | 8.3 | 0 | 0 |
| PE 6200 | | | | | | |
| Pluronic ™ | 0 | 8.3 | 0 | 0 | 0 | 0 |
| PE 6400 | | | | | | |
| Polyox WSR | 0 | 0 | 0 | 0 | 8.3 | 0 |
| N10 | | | | | | |
| Geropon | 0 | 0 | 0 | 0 | 0 | 8.3 |
| DOS PG | | | | | | |
| Pluronic ™ | 4.1 | 4.1 | 4.1 | 0 | 4.1 | 4.1 |
| PE 10400 | | | | | | |
| Morwet D- | 0 | 0 | 0 | 4.1 | 0 | 0 |
| 425 | | | | | | |
| Anti-freeze | 4.9 | 4.9 | 4.9 | 4.9 | 4.9 | 4.9 |
| agent | | | | | | |
| Viscosity | 0.12 | 0.12 | 0.12 | 0.12 | 0.12 | 0.12 |
| modifier | | | | | | |
| Biocides | 0.26 | 0.26 | 0.26 | 0.26 | 0.26 | 0.26 |
| Anti-foam | 0.41 | 0.41 | 0.41 | 0.41 | 0.41 | 0.41 |
| agent | | | | | | |
| Wetting | 0.16 | 0.16 | 0.16 | 0.16 | 0.16 | 0.16 |
| agent | | | | | | |
| Water | ad 100 | ad 100 | ad 100 | ad 100 | ad 100 | ad 100 |
| | (rest) | (rest) | (rest) | (rest) | (rest) | (rest) |

To evaluate the retention properties of the samples (Examples 1 to 6), the dynamic surface tension (DST) of the samples was measured using a Krüss Bubble Pressure Tensiometer BP 100. The different samples were measured at a concentration of 0.33% in water. Samples showing a surface tension of 55 mN/in or lower at a surface age of 75 ms are considered to have good retention properties, while samples showing a surface tension superior to 55 mN/in at a surface age of 75 ms are considered to have bad retention properties.

Example 1 showing a DST₇₅ₘₛ of 53 mN/in and Example 2 showing a DST₇₅ₘₛ of 54 mN/in are evaluated as samples with good retention properties. Formulations with improved retention properties are showing a favourable behaviour during the foliar application as the composition droplets better stick to the plant leaves.

To evaluate the stability of the samples (Examples 1 to 6), the viscosity of the samples was measured, as well as serum formation and the formation of sediment. These measurements have been performed initially after the preparation of the formulation as well as after 2 weeks storage at elevated temperatures. Storage was done at 54° C. as well as in a climate chamber with a cycling temperature between −10 and 50° C.

The viscosity was measured using a Brookfield viscosimeter using spindle S3 at 30 rpm. When the initial viscosity was below 1000 mPa and the deviation of the initial viscosity is not more than 10% over storage as above described, the viscosity was considered as good.

The serum formation was measured using graduated scale. When the serum formation was below 5% of the total formulation measurement, the serum formation was considered as good.

The formation of sediment was evaluated by slow decanting followed by visual assessment. Any formation of sediment is not tolerated. When no formation of sediment was visible, the result was considered as good.

All the results of DST and stability are gathered in Table 3.

TABLE 3

| Results | | Ex. 1 | Ex. 2 | Ex. 3 | Ex. 4 | Ex. 5 | Ex. 6 |
|---|---|---|---|---|---|---|---|
| DST | | Good | Good | Bad | Bad | Bad | Bad |
| Stability | Viscosity | Good | Good | Good | Good | Bad | Bad |
| | Serum | Good | Good | Bad | Bad | Good | Bad |
| | formation | | | | | | |
| | Sediment | Good | Good | Good | Bad | Good | Bad |
| | formation | | | | | | |

The example 1 according to the invention had an initial viscosity of 675 mPa and had after storage a deviation inferior to 2%, and the example 2 according to the invention had an initial viscosity of 588 mPa and had after storage a deviation inferior to 5%. Less than 5% of serum formation (of the total formulation measurement) as well as no formation of any sediment were observed in examples 1 and 2. The low and constant viscosity proves an excellent stability and result in easy handling of the formulation also after long storage times, e.g. after 2 weeks storage at elevated temperatures. Comparative examples 3-6 did not satisfy the required conditions in terms of DST and/or stability.

1. An aqueous composition comprising:
(a) at least 10% by weight of fludioxonil over the total weight of the composition,
(b) at least one polyoxyalkylene copolymer having an average molecular weight up to 4000 g/mol,
(c) at least one dispersing agent, said dispersing agent being a polyoxyalkylene copolymer having an average molecular weight superior to 4000 g/mol, and
(d) water.

2. A composition according to claim 1, characterized in that the composition comprises from 20 to 60% by weight of fludioxonil, and preferably from 30 to 50% by weight of fludioxonil, over the total weight of the composition.

3. A composition according to claim 1, characterized in that the polyoxyalkylene copolymer (b) has an average molecular weight up to 3000 g/mol.

4. A composition according to claim 1, characterized in that the composition comprises from 1 to 30% by weight of polyoxyalkylene copolymer (b), and preferably from 1 to 20% by weight of polyoxyalkylene copolymer (b), over the total weight of the composition.

5. A composition according to am claim 1, characterized in that the polyoxyalkylene copolymer (b) is a poly(ethylene oxide)poly(propylene oxide)-poly(ethylene oxide) block copolymer.

6. A composition according to claim 1, characterized in that the composition comprises from 0.1 to 20% by weight of dispersing agent, over the total weight of the composition.

7. A composition according to claim 1, characterized in that the dispersing agent (c) is a polyoxyalkylene copolymer having an average molecular weight from 5000 g/mol.

8. A composition according to claim 1, characterized in that the dispersing agent (c) is a poly(ethylene oxide)-poly(propylene oxide)-poly(ethylene oxide) block copolymer.

9. A composition according to claim 1, characterized in that the composition is a suspension concentrate (SC) or a suspoemulsion (SE).

10. A method of controlling or preventing an infestation of plants by fungal organisms, which comprises the foliar application of the composition according to claim 1.

11. A method according to claim 10, characterized in that the plant is oilseed rape.

12. Use of a composition according to claim 1 to control or prevent an infestation of plants by fungal organisms.
